(19) United States
(12) Patent Application Publication
(10) Pub. No.: US 2025/0322282 A1
(43) Pub. Date: Oct. 16, 2025

(54) APPARATUS AND METHODS FOR QUANTUM CLOCK CYCLE SHUTTLING

(71) Applicant: Universal Quantum LTD, Brighton (GB)

(72) Inventors: Zak David ROMASZKO, Brighton (GB); Harold GODWIN, Brighton (GB)

(21) Appl. No.: 19/182,506

(22) Filed: Apr. 17, 2025

Related U.S. Application Data
(63) Continuation of application No. PCT/GB2023/052753, filed on Oct. 20, 2023.

(30) Foreign Application Priority Data
Oct. 21, 2022 (GB) 2215572.5

(51) Int. Cl. G06N 10/40; G06N 10/20

(52) U.S. Cl. CPC G06N 10/40; G06N 10/20

(57) ABSTRACT

Disclosed herein is an apparatus comprising: a plurality of quantum processors; a controller configured to control the plurality of quantum processors; wherein the controller is configured to control the plurality of quantum processors to perform a process operation sequence, the process operation sequence being selected from a plurality of process operation sequences, each process operation sequence comprising a plurality of phases, each phase having a phase period and wherein the controller is configured to control the apparatus to operate as a single state machine such that all quantum processors controlled by the controller perform the same phase of the same process operation sequence at the same time.

### CROSS-REFERENCE

This application is a continuation of International Application No. PCT/GB2023/052753, filed on Oct. 20, 2023, which claims the benefit of United Kingdom (GB) Patent Application No. 2215572.5, filed on Oct. 21, 2022, each of which are incorporated herein in their entirety by reference.

### BACKGROUND OF THE INVENTION

Quantum computing in general, unlike so-called “classical computing”, relies on the quantum mechanical properties of particles or matter to produce or alter data. The data may be represented by quantum bits or “qubits”, which is a two state quantum mechanical system. Unlike classical computing, the qubit may be in superposition of quantum states. Another feature of quantum computing is the entanglement between qubits in which the state of one particle or atom is influenced by another particle or atom. Quantum mechanical qubits are able to encode information as combinations of zeros and ones simultaneously. Such properties open numerous complex numerical applications that are traditionally difficult for classical computers. Examples include artificial Intelligence, image processing and recognition, cryptography, or secure communications and so on. Within an ion hyperfine electronic states (Zeeman split states) can be revealed by the use of a magnetic field and the different electron levels used as the different qubit states and electrons moved between the levels using microwave radiation or lasers.

### SUMMARY OF THE INVENTION

In an aspect disclosed herein is an apparatus comprising: a plurality of quantum processors; a controller configured to control the plurality of quantum processors; wherein the controller is configured to control the plurality of quantum processors to perform a process operation sequence, the process operation sequence being selected from a plurality of process operation sequences, each process operation sequence comprising a plurality of phases, each phase having a phase period and wherein the controller is configured to control the apparatus to operate as a single state machine such that all quantum processors controlled by the controller perform the same phase of the same process operation sequence at the same time.

In some embodiments, each of the plurality of the process operation sequences has a different process operation sequence period. In some embodiments, different gate operations comprise a single function. In some embodiments, the controller is configured to control all the quantum processors to perform either the same process operation sequence or an identity operation during the same time period. In some embodiments, an identity operation comprises one of spin echo, sympathetic cooling, an identity gate and no operation. In some embodiments, the phase period is the maximum period over which each quantum processor performs the phase function. In some embodiments, each process operation sequence comprises a mapping phase and a gate function phase. In some embodiments, each process operation sequence comprises a mapping phase, a shuttling phase, a gate operation phase and a measurement phase, wherein the controller is configured to control each process to perform the same respective phase on each quantum processor simultaneously. In some embodiments, a process operation sequence comprises any qubit gate operation completed within the maximum gate operation period of the process operation sequence. In some embodiments, a first process operation sequence comprises only single qubit gate operations and a second gate operation sequence comprises two qubit gate operations and single qubit gate operations. In some embodiments, the first process operation sequence may comprise any single qubit gate operation completed within the maximum gate operation period. In some embodiments, each quantum processor comprises a plurality of electrodes and DACs, each electrode being independently controlled by a DAC. In some embodiments, the plurality of quantum processors comprises a two dimensional array of processors. In some embodiments, each quantum processor comprises an ion trap.

In an aspect disclosed herein is a quantum computer comprising an apparatus according to any one of the preceding claims.

In an aspect herein is a method of operating a quantum computer comprising a plurality of quantum processors and a controller, the method comprising: selecting a single process operation sequence from a plurality of process operation sequences, each process operation sequence comprising a plurality of phases, each phase having a phase period; and generating control signals to perform the same phase of the same process gate operation sequence at the same time on all the processors controlled by the controller to operate as a single state machine.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 depicts an array of electrodes in a quantum processor used in conjunction with the invention;

FIG. 2 depicts a two dimensional array of quantum processors;

FIG. 3 depicts a typical process operation sequence;

FIG. 4 depicts a plurality of process operation sequences;

FIG. 5 depicts an illustrative process operation sequence;

FIG. 6 depicts an illustrative process operation sequence;

FIG. 7 depicts an illustrative process operation sequence;

FIG. 8 depicts a series of single and two qubit gates; and

FIG. 9 depicts a decomposition of a CNOT gate.

### DETAILED DESCRIPTION OF THE INVENTION

In ion trap quantum computers ion traps can be used to control ions used in quantum computation and surface electrodes are used to generate electric fields to manipulate and trap the ions suspended in free space. The surface electrode potentials of an ion-trap are in turn controlled by DACs. State-of-the-art quantum computers use many DACs of the same type, for example 16 bit DACs with a better than 1 MHz update rate.

Ion traps are used to perform gates which perform quantum operations on the trapped qubit. Examples of quantum gates are Pauli gates, rotation gates (with arbitrary angles for instance), SWAP gates and CNOT gates. Some, such as phase (Z) gates are single qubit gates and others, such as the CNOT and SWAP are two qubit gates.

When performing a quantum algorithm there is preferably minimal delay between quantum operations. Ideally, gate operations are performed on every qubit simultaneously. However, the different gate operations have different durations. Generally, two qubit gates take significantly longer than single qubit gates. In turn three qubit gates take longer than two qubit gates.

The different durations of the qubit gates can create a long latency period while the longer duration gate operations are completed. Additionally this significantly increases the run time of the algorithm and therefore reduces the overall performance of the apparatus.

It is an aim of the present invention to minimize run time in a quantum algorithm. According to the invention there is provided an apparatus comprising a plurality of quantum processors, a controller configured to control the plurality of quantum processors, wherein the controller is configured to control the plurality of quantum processors to perform a process operation sequence, the process operation sequence being selected from a plurality of process operation sequences, each process operation sequence comprising a plurality of phases, each phase having a phase period wherein the controller is configured to control the apparatus to operate as a single state machine such that all quantum processors controlled by the controllers perform the same phase of the same process operation sequence at the same time.

The controller may comprise a plurality of sub controllers each controlling a plurality of quantum processors. As such, there are no fields or signals controlled by other/different controllers which coherently affect qubits in the quantum processors. As such, there are no fields or signals which coherently affect qubits in the quantum processors not controlled by the controller or one of the sub controllers. All fields or which coherently affect qubits in the quantum processors are controlled by the controller or sub controllers. All control signals from each of the sub controllers control all the quantum processors to perform the same function at the same time.

It may be, for example, that all the quantum processors on a single plate, or within a single computer perform the same phase of the same process operation sequence at the same time. It may be that there are a plurality of quantum processors. For example, there may be at least 10, at least 100 or over 1000.

During each phase all the quantum processors perform the same function. Different functions include mapping, cooling, shuttling, single qubit gate operations, two qubit gate operations, measurement. Multiple gate operations are treated as the same function, so different quantum processors may perform different gate operations during the same phase. A single qubit gate operation may be any single qubit gate operation. A two qubit gate operation may be any gate operation comprising two qubits or a single qubit gate.

Qubits scheduled for a gate operation which can be completed according to the selected process operation sequence undergo the process operation sequence, whereas those scheduled for a process operation sequence which cannot be completed within the selected process operation sequence have no operation performed. Thus the quantum processors are either performing the selected process operation sequence or not performing a process operation. Not performing a process operation includes performing an identity operation.

By having a plurality of process operation sequences, utility of the apparatus can be optimised. For example, if only a few qubits in a system are scheduled for lengthy gate operations but the rest are scheduled for short gate operations a shorter process operation sequence may be selected. At the next iteration, when there may be more qubits scheduled for longer gate operations a longer gate operation sequence may be selected. Thus, redundancy in the apparatus is minimised.

A plurality of the process operation sequences may comprise a plurality of different phases, each phase having a phase period. All the processors perform either the same process operation sequence or an identity operation during the same time period. An identity operation is an operation in which the state of the qubit remains unchanged. For example, it may include spin echo and sympathetic cooling and no operation.

Each process operation sequence may comprise a shuttling phase, an observing phase, a gate operation phase and a measurement phase, wherein the controller is configured to control each process to perform the same respective phase on each processor simultaneously. Each phase of each process operation sequence may have a maximum period.

A process operation sequence may comprise any qubit gate operation completed within the maximum gate period of the process operation sequence. A first gate operation sequence comprises only single qubit gate operations and a second gate operation sequence comprises two qubit operations. Two qubit gate operations are generally longer than single qubit gate operations so this groups the longer gate operations together. The second gate operation sequence may comprise both two qubit operations and single qubit gate operations. The first gate operation sequence may comprise any single qubit gate operation completed within the maximum gate operation period.

Each quantum processor may comprise a plurality of electrodes and DACs, each electrode being independently controlled by a DAC. Each processor may comprise an ion trap which may be a surface ion trap. The plurality of quantum processors may comprise a two dimensional array of quantum processors.

According to the invention there is provided a quantum computer comprising an apparatus as described above. According to the invention there is provided a method of operating a quantum computer comprising a plurality of quantum processors and a controller, the method comprising selecting a single process operation sequence from a plurality of process operation sequences, each process operation sequence comprising a plurality of phases, each phase having a phase period and performing the same phase of the same process gate operation sequence on all the processors at the same time so that the quantum computer operates as a single state machine.

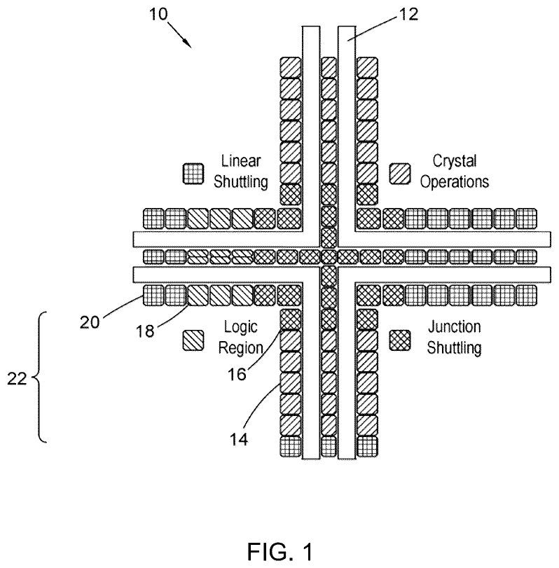

Referring to FIG. 1, there is an example arrangement of electrodes in a quantum processor in conjunction with this invention. FIG. 1 shows an x-junction device 12 in a trapped ion quantum computer 10. The x-junction 12 comprises a plurality of electrodes 22 configured to trap an ion in an area of the x-junction device 12. Each electrode 22 is driven by a DAC to carry out the function of the area of the x-junction device 12. The x-junction device 12 is divided into areas. The areas of the x-junction device 12 can be divided into crystal operations 14, junction shuttling 16, logic region/gate zone 18 and linear shuttling 20 depending on the function being carried out in each area.

The x-junction is divided into four sections, a north section (above the centre as depicted on FIG. 1), an east section (right of the centre as depicted on FIG. 1), a south section (below the centre as depicted on FIG. 1) and a west section (left of the centre as depicted on FIG. 1). If there is no ion within the section there may be no signal applied to any of the electrodes. Alternatively, there may be a signal, but no change in signal. Similarly if an ion is being shuttled in from the left to the centre no signals may be applied to the electrodes in the north east or south sections.

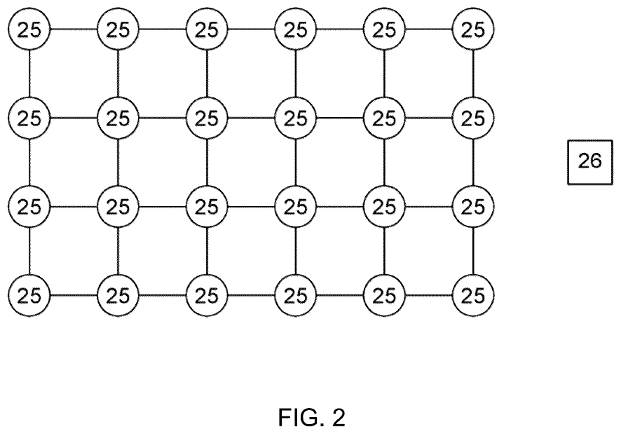

A quantum computer typically has a plurality of quantum processors (hereinafter referred to as “processors”). In the example depicted in FIG. 2 there is a two dimension array of processors 25 and a controller 26. Each processor comprises a zone in which gate operations may be performed. Examples of gate operations are Pauli gates, rotation gates, swap gates, and CNOT gates. The qubits are shuttled between processors as described above. A gate operation will then occur before the qubits are shuttled between processors again. According to the invention the controller 26 controls all the processors in the apparatus to perform the same function simultaneously so all the processors are shuttling, performing a gate operation or measuring simultaneously. The gate operation performed by each individual processor at a particular time may vary so some may perform a first gate operation and others a second gate operation.

While some, or most processors are performing the same function simultaneously some will be performing an identity operation. An identity operation is an operation which maintains the status of a qubit. Identity operations can comprise either no operation at all, or may comprise cooling or spin echo for noise cancelling.

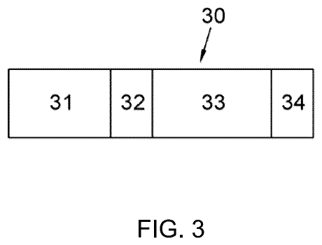

There are typically a plurality of process operation sequences in which the qubit is initially shuttled into position. In order to shuttle one or more qubits the qubits are mapped. A typical process operation sequence comprises a plurality of phases e.g. a mapping phase 31; a shuttling phase 32, a gate operation phase 33 and then a measurement phase 34, as depicted in the process operation sequence 30 of FIG. 3. According to the invention each of these phases has a period for each different process operation sequence.

Every processor 25 within the quantum computer performs the same process operation sequence 30, or an identity operation (comprising no function, cooling or spin echo cancelling or an identity gate operation). For all the processors 25 performing the process operation sequence 30 (rather than an identity operation) all the processors perform a shuttling function during an initial shuttling phase 31. Some qubits may be complete shuttling before the end of the shuttle phase but the respective processor will not begin observation. Once the mapping phase has finished all processors 25 then begin the shuttling phase 32, during which the qubits are shuttled. Some of the qubits may not need to be shuttled and therefore the respective processor preforms an identity operation. Again, observation of some qubits may be complete before the end of the mapping phase, but the processor will not move onto the gate operation. If a processor completes a phase before the phase period is complete it may perform an identity operation for the remaining duration of the phase period. Once the period for observation is complete all processors begin the gate operation phase 33. Different processors may perform different gate operations during the gate operation phase, but they will each be performing a gate operation or an identity operation. For example, some may be performing rotation about the x axis, some about the y axis. However, they will all be performing a gate function. Again, some of the gate operations will be complete earlier than others, but none of the processors will begin measurement before the gate operation phase period is complete. Then all the processors begin the measurement phase.

In this way, each of the phases has a fixed maximum period. Example sequences are: Shuttling phase, mapping phase, gate phase; Gate phase, mapping phase, shuttling phase; Shuttling phase, measurement phase; Shuttling phase, mapping phase, gate phase, mapping phase, measurement phase; Measurement phase, shuttling phase, mapping phase, gate phase; Mapping phase, cooling phase, gate phase, measurement phase; Measurement phase, shuttling phase, cooling phase, mapping phase, single qubit gate phase, two qubit gate phase, single qubit gate phase. As will be appreciated, this is not a limiting list of sequences and there may be many further variations.

As described above, each of the phases has a maximum duration after which the next phase is begun. If, for example, the function (e.g. shuttling or gate operation) is incomplete the subsequent functions of the process operation sequence will not be performed for that process/qubit and the process/gate will begin again during the next iteration of a process operation sequence.

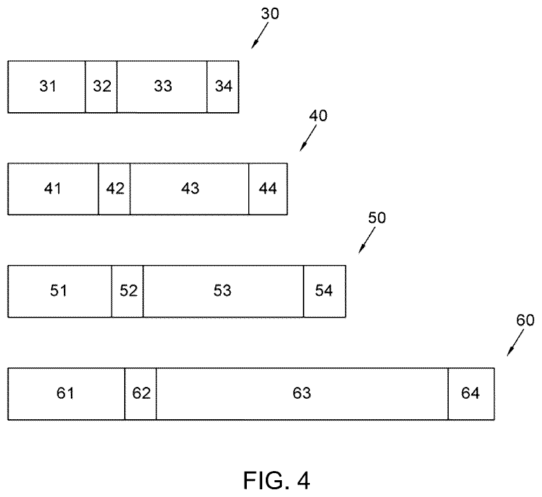

FIG. 4 depicts a plurality of process operation sequences 30, 40, 50, 60. As can be seen they each have different durations and each of the phases within each has a different duration. In this example each sequence has a shuttling phase, 31, 41, 51, 61, a mapping phase, 32, 42, 52, 62 a gate operation phase, 33, 43, 53, 63 and a measurement phase 34, 44, 54, 64. Sequences 30 and 40 are both single qubit gate operation sequences, but with different periods for the different phases. In particular gate operation phase 43 is longer than gate operation phase 33 so gate operation sequence 40 may be used when longer duration gates are used. Gate operation sequence 50 is a two qubit gate operation sequence with a longer period for the gate operation phase as two qubit gate operations are generally longer than single bit gate operations. Gate operation sequence 60 is a three qubit gate operation which has a longer gate operation phase still.

Each of the different gate operation sequences has a different gate operation phase duration. The controller 26 selects a gate operation sequence and all the gates within the two dimensional array of gates perform that gate operation sequence (or an identity operation). In this way the apparatus operates as a single state machine because all the gates are performing the same function at the same time. Qubits which are scheduled to undergo a gate operation which takes longer than the gate operation of the selected sequence, or for which the shuttling (or another) phase is too short are held until the next process operation sequence, which may have a longer gate operation phase or longer shuttling phase, and the gate operation can be completed then.

The periods of the phases in each of the process operation sequences is set, but is set to a period in which most of the gates would have completed the required operation. For example, shuttling between processors can take a variable amount of time (largely based on the distance a qubit moves). The shuttle phase of each process operation sequence has a fixed period during which qubits are shuttled. Even if the shuttling of some qubits is incomplete at the end of the shuttle phase of the process operation sequence the process operation sequence will proceed and the processor with the qubit for which shuttling is incomplete will simply perform an identity operation. Shuttling than then be completed during the next process operation sequence. Although this is described in relation to shuttling it could apply to any of the phases.

If the gate operation scheduled for most of the qubits is a single gate operation a gate operation sequence such as 30 can be selected. Some of the qubits may be scheduled for a two qubit gate operation but those gate operations can wait until the next iteration. This avoids a long latency period while a few qubits undergo two qubit gate operations. At the next iteration, or gate operation sequence, a higher proportion of qubits may be scheduled to undergo a two qubit gate operation and so gate operation sequence 50 may be selected. During a gate operation 50 it may be just two qubit gate operations which are completed, but in an alternative arrangement single qubit gate operations may also be completed. Indeed any gate operations which can be completed in a period shorter than the gate operation phase may be completed. During the following iteration a shorter, single qubit gate operation sequence may be selected. However, the order in which gate operations are performed should fulfil gate commutation rules.

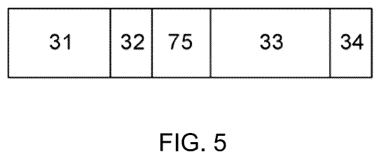

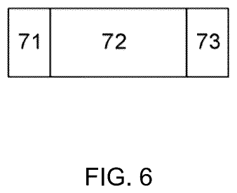

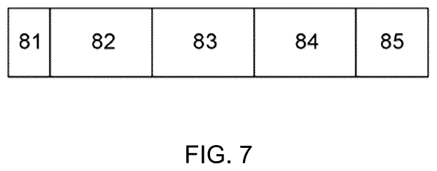

Thus the controller 26 selects the gate operation sequence to optimise the performance of the apparatus as a whole to reduce latency. Although a sequence of shuttling, observing, gate operation and measurement has been depicted here other sequences could alternatively be used and one of these is depicted in FIG. 5 which has an additional count phase 75. Further alternative sequences are depicted in FIGS. 6 and 7.

During a selected gate operation sequence all the processors are either performing the gate operation sequence or an identity operation. The processors performing the gate operation sequence may not perform every phase of the sequence. For example, if no shuttling is necessary for a particular processor then the processor may not perform that phase in the sequence but, once the subsequent phase has begun, will perform that phase.

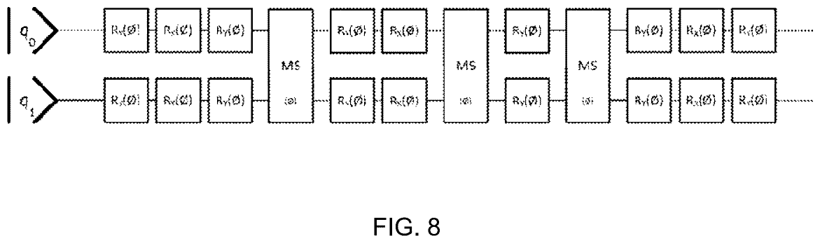

Any arbitrary two qubit interaction can be decomposed into a series of one and two qubit gates. FIG. 8 depicts a series of single qubit and two qubit gates into which any two qubit interaction can be broken down, where R_{y}(ϕ) is a rotation of ϕ around the y axis, Rₓ(ϕ) is a rotation of ϕ around the x axis and MS is a Molmer-Sorensen gate.

It is clear from this that in a sequence there are often more single qubit gate operations than two qubit gate operations. For scheduling purposes it is worth doing more of the longer, two qubit gate operations when there are more, rather than allocating sufficient gate operation time within every gate operation cycle.

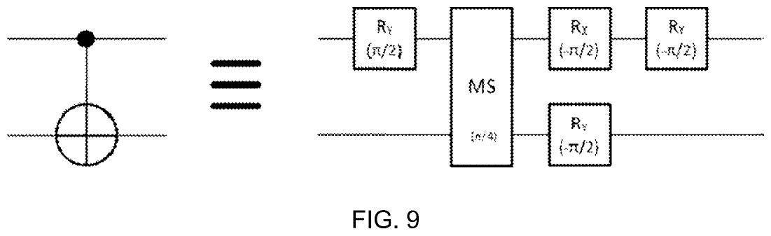

As a further example a CNOT gate can be decomposed into a series of Rx, Rx and Molmer-Sorensen gates as shown in FIG. 9.

The process operation sequences in FIG. 4 have been described as single qubit, two qubit or three qubit process operation sequences. However, alternatively, they may be defined not by the number of qubits in the gate operation but by the maximum duration of the gate operation phase. Thus in the first process operation sequence 30 any gate operation which can be completed within the gate operation phase 33 may be used. In the second process operation sequence 40 any gate operation which can be complete within the gate operation phase 43 may be used. In the third gate operation sequence any gate operation which can be completed in the gate operation phase 53 (whether that is single qubit, two qubit or three qubit) may be completed.

According to the invention the plurality of process operation sequences each have a plurality of phases, each phase having a phase period.

The controller controls all the quantum processors controlled by the controller to perform the same phase of the same process operation sequence at the same time. Thus, it operates as a single state machine.

All control signals, from the controller, control all the quantum processors controlled by the controller to perform the same phase of the same process operation sequence i.e. no control signals from the controller control quantum processors to perform a different phase or operation.

The control signals may control electromagnetic fields, for example, magnetic fields or radio waves and these are all involved in the same phase of the same process operation sequence. There may be individual fields for individual quantum processors and/or there may be global fields. However, all the control signals, from the controller, controlling quantum processors generate signals or fields to perform the same phase of the same process operation sequence on quantum processors. As an example, all the electromagnetic fields generated by control signals from the controller to quantum processors comprise the same phase of the same process operation sequence.

Thus, all the fields (controlled by controllers) affecting the quantum processors are controlling the quantum processors to perform the same phase of the same process operation sequence i.e. there are no control signals coherently affecting the qubits to perform anything other than the same phase of the same process operation sequence.

“and/or” where used herein is to be taken as specific disclosure of each of the two specified features or components with or without the other. For example “A and/or B” is to be taken as specific disclosure of each of (i) A, (ii) B and (iii) A and B, just as if each is set out individually herein.

Unless context dictates otherwise, the descriptions and definitions of the features set out above are not limited to any particular aspect or embodiment of the invention and apply equally to all aspects and embodiments which are described.

It will further be appreciated by those skilled in the art that although the invention has been described by way of example with reference to several embodiments. It is not limited to the disclosed embodiments and that alternative embodiments could be constructed without departing from the scope of the invention as defined in the appended claims.

1-16. (canceled)

17. A system comprising:
a quantum computer comprising a plurality of quantum processors; and
a controller configured to direct the plurality of quantum processors to operate as a state machine.

18. The system of claim 17, wherein the state machine comprises a single state machine.

19. The system of claim 18, wherein the controller is configured to perform a process operation sequence on the plurality of quantum processors to direct the plurality of quantum processors to operate as the state machine.

20. The system of claim 19, wherein the process operation sequence comprises at least one phase during which each quantum processor of the plurality of quantum processors is configured to perform a same operation or an identity operation.

21. The system of claim 19, wherein the process operation sequence is selected from a plurality of process operation sequences.

22. The system of claim 21, wherein at least one process operation sequence of the plurality of process operation sequences comprises a plurality of phases, and wherein at least one phase of the plurality of phases comprises a period during which an operation is performed.

23. The system of claim 22, wherein the at least one process operation sequence comprises a phase for performing one or more gate operations on the plurality of quantum processors, wherein a period of the phase provides a maximum period of a gate operation of the one or more gate operations scheduled during the at least one process operation sequence.

24. The system of claim 21, wherein a first process operation sequence of the plurality of process operation sequences comprises a first phase with a first period configured for performing single qubit gate operations and not two qubit gate operations, and wherein a second process operation sequence of the plurality of process operation sequences comprises a second phase with a second period for performing two qubit gate operations and single qubit gate operations.

25. The system of claim 19, wherein a process operation of the process operation sequence comprises one or more of a mapping phase, a shuttling phase, a gate operation phase, or a measurement phase.

26. The system of claim 25, wherein the process operation sequence comprises the gate operation phase.

27. The system of claim 26, wherein the gate operation phase comprises one or more of Pauli gates, rotation gates, swap gates, or controlled NOT (CNOT) gates.

28. The system of claim 18, wherein the controller is configured to schedule a portion of the plurality of quantum processors to perform an identity operation instead of a gate operation during a first process operation sequence.

29. The system of claim 28, wherein the gate operation for a subset of the plurality of quantum processors is scheduled to occur during a second process operation sequence, wherein the second process operation sequence has a longer gate operation phase period than the first process operation sequence.

30. The system of claim 28, wherein the identity operation comprises one or more of spin echo cancelling, sympathetic cooling, an identity gate, or no operation.

31. The system of claim 17, wherein a quantum processor of the plurality of quantum processors is configured to control one or more qubits.

32. The system of claim 17, wherein a quantum processor of the plurality of quantum processors comprises a plurality of electrodes and a plurality of digital to analog converters (DACs).

33. The system of claim 32, wherein an electrode of the plurality of electrodes is independently controlled by a DAC of the plurality of DACs.

34. The system of claim 17, wherein the quantum processor is configured to receive control signals from the controller to perform a process operation sequence.

35. The system of claim 17, wherein the plurality of quantum processors comprises a two-dimensional array of quantum processors.

36. The system of claim 17, wherein the plurality of quantum processors comprises plurality of ion traps.
